(19) United States
(12) Patent Application Publication
(10) Pub. No.: US 2008/0291659 A1
(43) Pub. Date: Nov. 27, 2008

(54) Table Having Luminescent Device

(76) Inventor: Steve Huang, Taichung Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/055,364

(22) Filed: Mar. 26, 2008

(30) Foreign Application Priority Data
May 24, 2007 (TW) 96118544

(51) Int. Cl. F21V 9/16; G09F 13/04

(52) U.S. Cl. 362/84; 362/97

(57) ABSTRACT

A table comprises a tabletop penetrable by light, at least one pedestal supporting the tabletop from a surface and a luminescent panel including a side attached to an underside of the tabletop. The light produced by luminescent panel can pass through the tabletop.

### BACKGROUND OF THE INVENTION

1. Field of the Invention

The present invention relates to a table, in particular to a table having luminescent device for illuminative and decorative purposes.

2. Description of the Related Art

Tables equipped with lightings and the lightings used for illuminative and decorative purposes of tabletops have been a known art. For example, Taiwan Patent Number M272441 discloses a table structure having a pedestal, a translucent tabletop mounted on top of the pedestal, and LED-decorated illuminations installed underneath the tabletop or on the pedestal which light the translucent tabletop for providing illuminative and decorative effects on the tabletop.

While the LED illuminations may be acceptable to light and decorate the tabletop, it is not an easy step to use and arrange LEDs to a complicated shape of decorative patterns. Furthermore, the more complex the pattern is, the more LEDs are required, and thus resulting in complex design of circuit and added weight and the cost of maintenance.

The present invention is, therefore, intended to obviate or at least alleviate the problems encountered in the prior art.

### SUMMARY OF THE INVENTION

It is therefore an object of the present invention to provide a table or a luminescent device for producing light to a table, which overcomes the hereinbefore mentioned problems.

Accordingly, the object is achieved by providing a table that includes a tabletop penetrable by light, at least one pedestal supporting the tabletop from a surface and a luminescent panel including a side attached to an underside of the tabletop. The light produced by luminescent panel can pass through the tabletop.

The luminescent panel can be controlled on and off through a switch member or a sensor box. The sensor box could be a light-detect type or a user-touch type.

In another embodiment, a luminescent device for producing light to a table includes a luminescent panel attached to the table. The table includes a tabletop penetrable by light and at least one pedestal supporting the tabletop from a surface. The luminescent device includes a switch member for controlling on and off of the luminescent panel. Alternatively, the luminescent device includes a sensor box for controlling on and off of the luminescent panel. The sensor box could be a light-detect type or a user-touch type.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

FIG. 1 is a perspective view of a luminescent device designed for a table.

FIG. 2 is an exploded perspective view of the table of FIG. 1.

FIG. 3 is a side view of the table of FIG. 1.

FIG. 4 shows the table of FIG. 1 but with the luminescent device having different luminescent patterns.

FIG. 5 is a perspective view of an alternate luminescent device designed for a table.

FIG. 6 is an exploded perspective view of the table of FIG. 5.

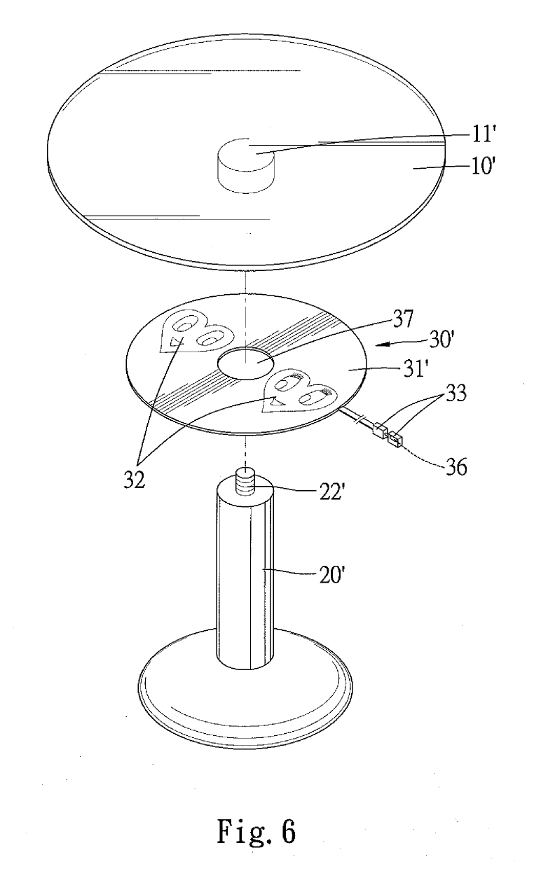

FIG. 7 is a perspective view of an alternate luminescent device designed for a table.

FIG. 8 shows the table of FIG. 7, with illuminative device being turned off by a sensor box.

FIG. 9 shows the table of FIG. 7, with illuminative device being turned on by a sensor box.

### DETAILED DESCRIPTION OF THE PREFERRED EMBODIMENT

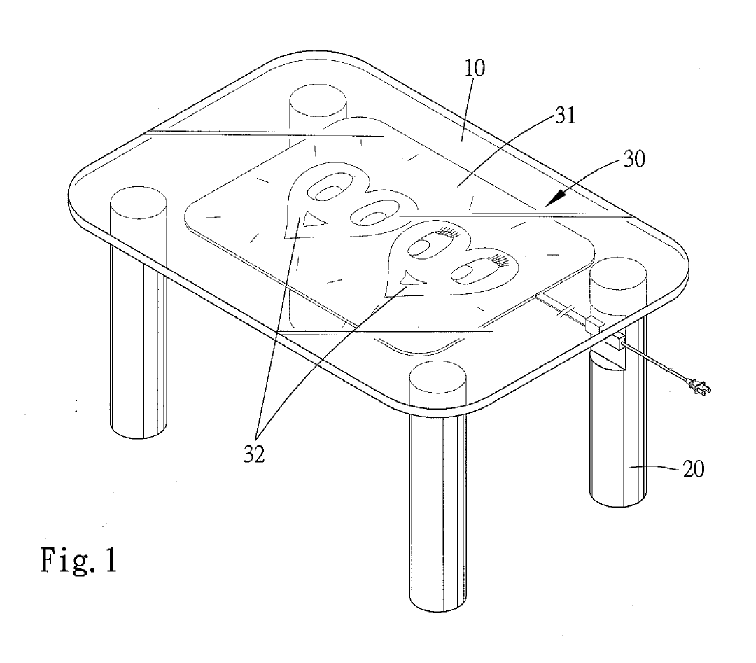

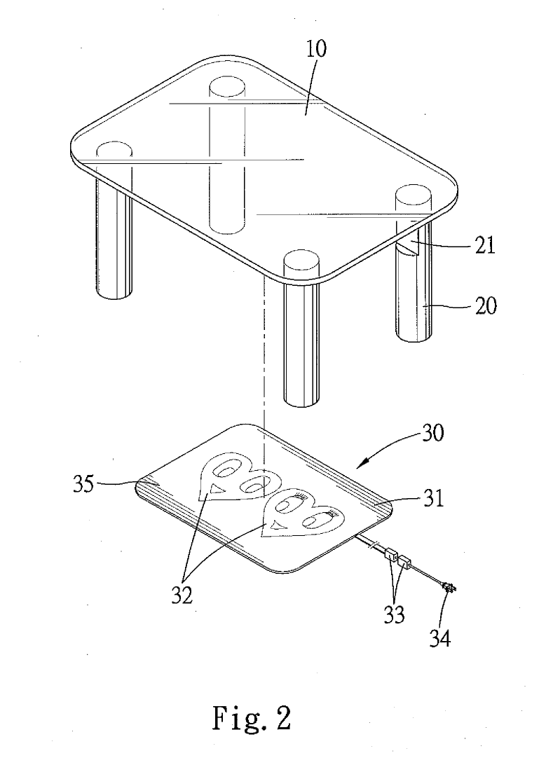

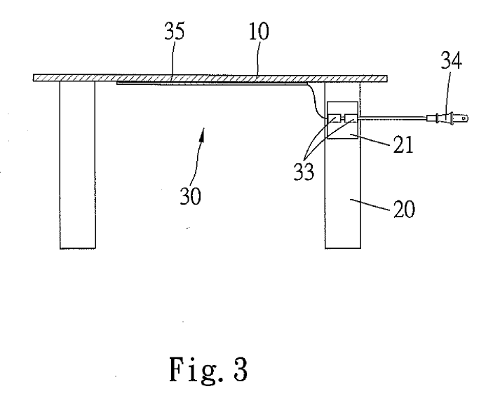

Referring to FIGS. 1 through 3, a tabletop 10 which is penetrable by light (i.e. either clear or translucent) has a rectangular periphery, which would not be used as limitation to the tabletop 10. The tabletop 10 has an upperside on which things are put and an underside.

Four pedestals 20 serve to support the tabletop 10 from a surface and each pedestal 20 has one end mounted to the underside of the tabletop 10 and another end rest on the surface.

A luminescent device 30 is configured to operate under power provided by electrical cord 34. The luminescent device 30 includes a luminescent panel 31 having a rectangular periphery. However, the luminescent panel 31 may have other variations in the shape of the periphery. The luminescent panel 31 has a side attached to the underside of the tabletop 10 and the said side uses adhesive 35 thereon for attachment with the underside of the tabletop 10. In this embodiment, the adhesive 35 allows multi-times of use.

Patterns 32, two as an example here, are formed on said side of the luminescent panel 31 and can be illuminative under the luminescence-effect of the panel 31. Each of the patterns 32 is capable of producing line illumination.

A switch member 33 which serves to control on and off of the luminescent panel 31 as well as degree of lumen of the luminescent panel 31, is connected to the panel 31 and is stably mounted in a recess 21 formed in one of the pedestal 20 as in this embodiment.

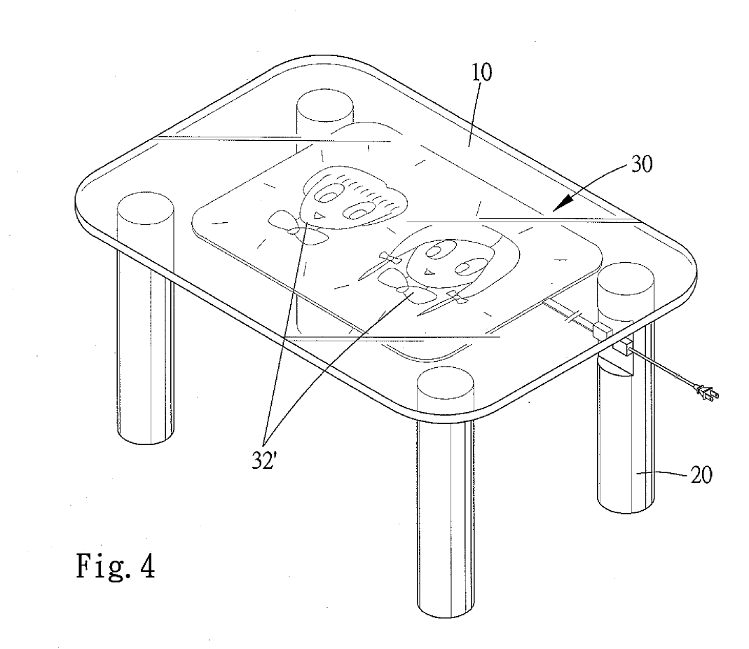

Turning now to FIG. 4, the luminescent panel 31 includes patterns 32′ rather than the patterns 32 shown in FIGS. 1-3. This is to show that other sophisticated patterns, like patterns 32′, can be created without requirements of further illuminations.

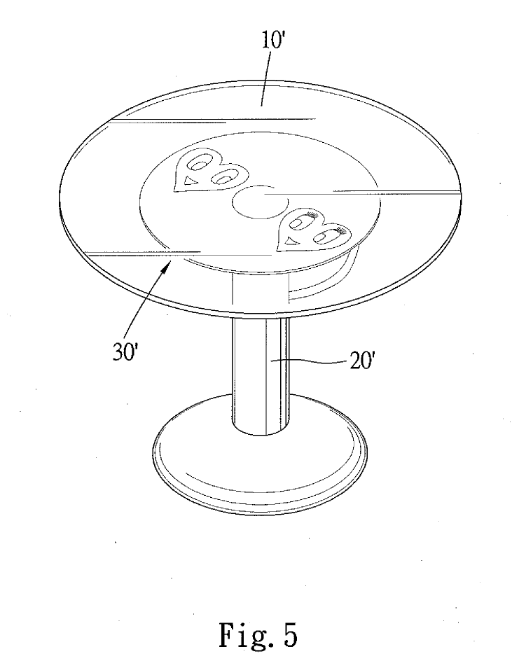

FIG. 5 shows an alternative luminescent device 30′ designed for a table. In this embodiment, the table includes a tabletop 10′ with a circular periphery rather than a rectangular periphery, which as noted above, wouldn't be used as a limitation. This tabletop 10′ has an engaging portion 11′ located on the underside thereof, and the engaging portion 11′ is inserted through a cutout hole 37 on a luminescent panel 31′, and is thereafter joined with an engaging end 22′ of pedestal 20. Accordingly, the luminescent panel 31′ can locate stably under the tabletop 10′. In this regard, the adhesive 35 would be unnecessary, but could still be used. Also, the luminescent device 30′ in this embodiment is operated under power provided by a battery 36. The battery 36 is housed in the switch member 33.

Though not shown, it should be understood that the luminescent device 30′ can be operated under power provide by electrical cord 34. Similarly, the luminescent device 30 can be operated under power provided by the battery 36.

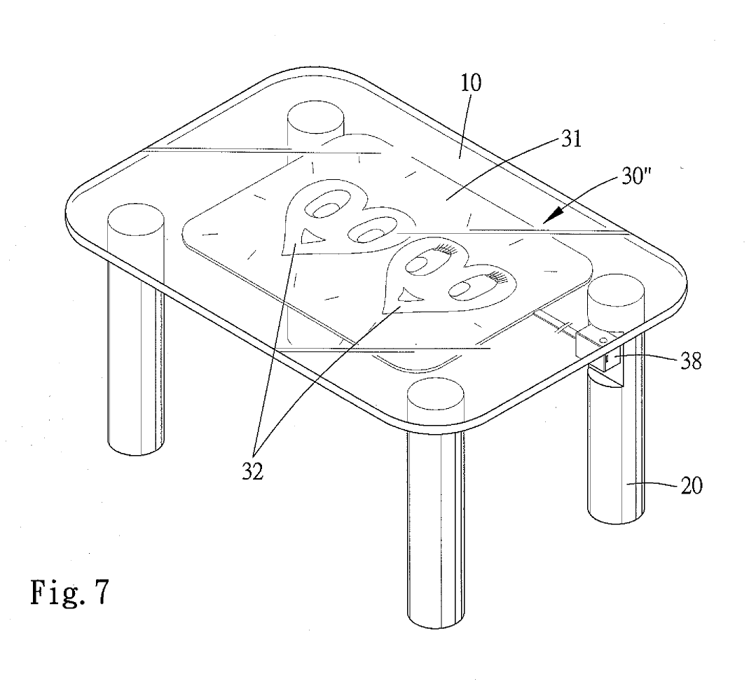

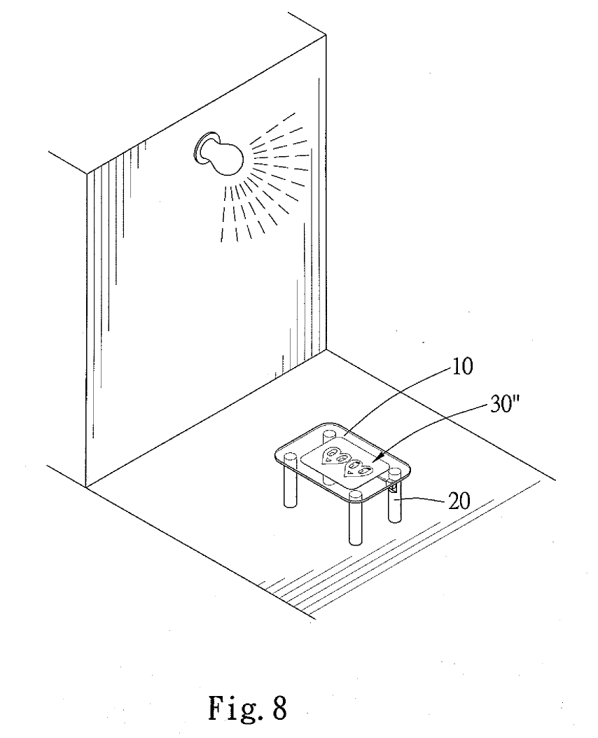

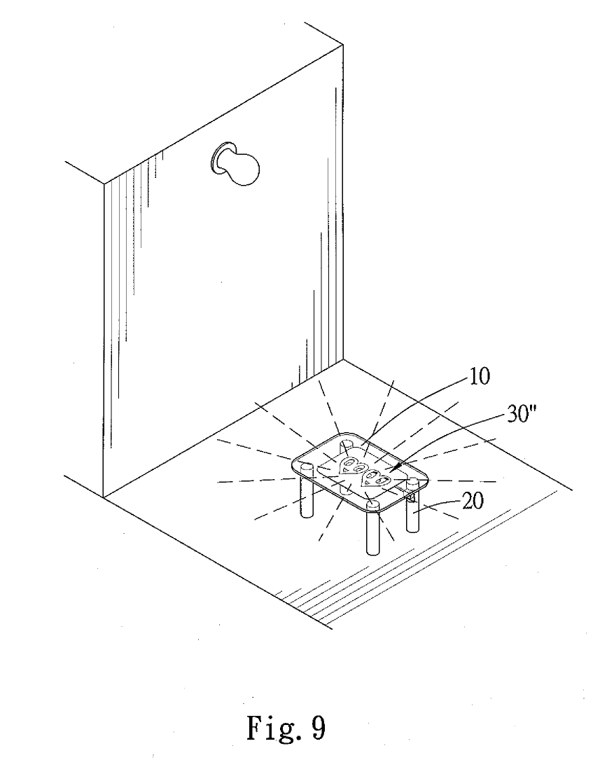

FIGS. 7-9 show an alternative luminescent device 30″ designed for a table This embodiment is similar to the first embodiment except that the switch member 33 is replaced by a sensor box 38. The sensor box 38 can control on and off of the luminescent panel 31 of the luminescent device 30″. The sensor box 38 can be of a light-detect type. For example, when the sensor box 38 detects light, the luminescent panel 31 is turned off and when the sensor box 38 detects no light, the luminescent device 31 is turned on. Alternatively, the sensor box 38 can be of a user-touch type. For example, when the sensor box 38 is touched, the luminescent panel 31 can be turned on, and by touching it again, the luminescent device 30 can be turned off.

While the specific embodiments have been illustrated and described, numerous modifications come to mind without significantly departing from the spirit of invention and the scope of invention is only limited by the scope of accompanying claims.

What is claimed is:

1. A table comprising:
a tabletop penetrable by light;
at least one pedestal supporting the tabletop from a surface;
a luminescent panel including a side attached to an underside of the tabletop and;
wherein light produced by luminescent panel can pass through the tabletop.

2. The table as claimed in claim 1 wherein said side of luminescent panel comprises adhesive thereon to attach to the underside of the tabletop.

3. The table as claimed in claim 2 wherein the adhesive has a multi-times usage.

4. The table as claimed in claim 1 wherein the luminescent panel is operated under power provided by electrical cord.

5. The table as claimed in claim 1 wherein the luminescent panel is operated under power provided by a battery.

6. The table as claimed in claim 1 further comprising a switch member controlling on and off of the luminescent panel as well as degree of lumen thereof.

7. The table as claimed in claim 1 further comprising a sensor box controlling on and off of the luminescent panel.

8. The table as claimed in claim 7 wherein the sensor box is of a light-detect type.

9. The table as claimed in claim 7 wherein the sensor box is of a user-touch type.

10. A luminescence device for producing light to a table comprising:
a luminescent panel including a side attached to the table and;
wherein the table comprising:
a tabletop penetrable by light;
at least one pedestal supporting the tabletop from a surface.

11. The luminescence device as claimed in claim 10 wherein the luminescent panel comprises adhesive thereon to attach to an underside of the tabletop.

12. The luminescence device as claimed in claim 11 wherein the adhesive has a multi-times usage.

13. The luminescence device as claimed in claim 10 wherein the luminescent panel is operated under power provided by electrical cord.

14. The luminescence device as claimed in claim 10 wherein the luminescent panel is operated under power provided by a battery.

15. The luminescence device as claimed in claim 10 further comprising a switch member controlling on and off of the luminescent panel as well as degree of lumen thereof.

16. The luminescence device as claimed in claim 10 further comprising a sensor box controlling on and off of the luminescent panel.

17. The luminescence device as claimed in claim 16 wherein the sensor box is of a light-detect type.

18. The luminescence device as claimed in claim 16 wherein the sensor box is of a user-touch type.
